(19) United States
(12) Patent Application Publication
(10) Pub. No.: US 2019/0242369 A1
(43) Pub. Date: Aug. 8, 2019

(54) DOUBLE-LAYER COMPONENT, METHOD FOR PRODUCING A DOUBLE-LAYER COMPONENT AND HEAT ENGINE COMPRISING A PLURALITY OF DOUBLE-LAYER COMPONENTS

(71) Applicant: Martin Huber, Dusseldorf (DE)

(72) Inventor: Martin Huber, Dusseldorf (DE)

(21) Appl. No.: 16/343,400

(22) PCT Filed: Oct. 19, 2017
(86) PCT No.: PCT/EP2017/076749

§ 371 Date: Apr. 18, 2019

(30) Foreign Application Priority Data
Oct. 20, 2016 (DE) 10 2016 012 554.3

(51) Int. Cl. F03G 7/06; B32B 7/027; B32B 27/32; B32B 27/34; B32B 27/08; B32B 27/36

(52) U.S. Cl. CPC F03G 7/06; B32B 7/027; B32B 27/32; B32B 27/34; B32B 27/08; B32B 27/36; B32B 2250/02; B32B 2603/00; B32B 2262/106; B32B 2264/108; B32B 2307/732; B32B 2307/72; B32B 2307/30

(57) ABSTRACT

The invention relates to a double-layer component (1) having a first layer (2) and a second layer (3), wherein the layers (2, 3) are connected to one another, wherein the two layers (2, 3) have different coefficients of thermal expansion, wherein the first layer (2) comprises a first plastic and the second layer (3) comprises a second plastic or carbon fibres, wherein the double-layer component (1) is reversibly deformable under the influence of heat. The double-layer component (1) is improved in that the double-layer component (1) can be inserted into a heat engine (4), wherein the thickness of the double-layer component (1) is at least 0.1 mm, wherein the thickness of the double-layer component (1) is 5 cm or less than 5 cm.

“Double layer component, method for producing a Bilayer component and heat engine having a plurality of Bilayer components”

The invention relates to a double-layer component, a method for producing a double-layer component, and a heat engine having the features of the preambles of the independent claims.

The bilayer component has a first and a second layer, the two layers are bonded together. The two layers have a different thermal expansion coefficient. The thermal expansion coefficient indicates how the length of a substance changes at a certain temperature change. Both layers are made of a plastic material. Characterized in that the layers have a different coefficient of thermal expansion, the double layer component under the influence of heat is reversibly deformable as it is known for example from bimetal stripes. The bilayer components show a bimetallic effect. Various bilayer components are known, which are used for shading.

From generic EP 0369080 A1, a double layer component in the form of a plastic sheet from a self-rolling material is known. The plastic sheet consists of two layers having different expansion characteristics. In the ground state, the sheet is rolled. The double-layer material consists of a sheet of polyethylene, which is laminated to aluminum foil, which has been deposited on a stretched polyethylene film. The first layer of the plastic material is heated and stretched and is applied to a non-stretched layer.

This generic type bilayer component and the manufacturing method described, have the disadvantage that the scope of such bilayer component is substantially limited to shading. The thickness of such films is in particular in the micrometer range. The double-layer component produces only a small force at a heat change, while sufficient to roll in, no further use of this bimetallic effect is possible.

More bilayer components for shading are known for example from DE 196 29 237 C2. Here, a double layer device for temperature-dependent shading of components, in particular solar collectors, windows or the like are known. Here, a uniaxially stretched plastic film, an unstretched film and an insulating layer are used. The uniaxially stretched plastic film has in the direction of stretching a thermal expansion coefficient which differs greatly from the linear expansion coefficient of the other film in the stretching direction. In particular, a uniaxially stretched polymer film is used as the inner film in combination with aluminum foil.

From U.S. Pat. No. 3,430,441 and FR854 030, a heat engine in the form of a wheel is known. The wheel has several spokes which are formed by double-layer components in the form of bimetallic strips.

From DE 26 17 577 a cover in the form of a transparent web and a plurality of arranged slats on one side of the web are known. The angle between the surface and the web and the lamellar plane can be changed. The fins are flexible and consist of a thermoplastic material, wherein the slats are composed of several layers. The layers have different thermal expansion coefficients. At a high temperature by solar radiation, the slats change shape. The slats are made of polyvinyl chloride (PVC).

From DE 27 09 207 A1, a heat-sensitive Venetian blind from a closed-cell soft foam sheet is known, where the plate is divided by incisions into lamellae. The lamellae thus formed are on some surfaces laminated with a flexible sheet of material with the lowest possible coefficient of thermal expansion. The soft foam sheet may be foamed polyethylene. The laminated sheet is made of steel.

The goal of the invention is to improve the generic type bilayer component.

This goal is solved by a double layer device with the features of claim 1.

The double-layer component can be used in a heat engine, wherein the thickness of the dual layer component is at least 0.1 mm preferably 0.5 mm. The thickness is preferably not less than 0.5 mm and not more than 5 cm, especially not more than 1 cm, preferably not more than 5 mm. The thinner the stripe is, the greater the bending, but the lower the force. With a double-layer component a heat engine can be built in a very cost-effective manner, the double-layer components can create sufficiently large forces in the engine. The width of the double layer device has no effect on the magnitude of the bending, but the force that is produced by the bilayer component. The wider the double layer component is, the greater the force. Preferably, the width of the double-layer component is between 1 cm and 50 cm, in particular between 1 cm and 30 cm. A greater width may be necessary if a greater heat engine needs to be constructed. In a particularly preferred embodiment, the heat engine is dimensioned such that the double-layer components have a width of 1 to 2 cm.

The length of the double-layer component also affects the bending. The longer the bilayer component is, the greater the bending and the greater are the forces that can be applied from the double-layer component. The length of the double-layer component is preferably between 5 cm and 100 cm. In a particularly preferred embodiment, the length is between 10 cm and 20 cm.

In a particularly preferred embodiment, the bilayer component is in the form of a stripe. The cross-section of the stripe is in particular rectangular. The stripe is significantly longer than wide. The width is preferably greater than the thickness. The exact ratios of length to width to thickness are a matter of interpretation of the use case.

The use of a double-layer component with two layers of plastic has the advantage that the temperature range in which the double layer component can work is well usable. The usable temperature range can be in particular between −20° C. and +40° C. The maximum temperature for continuous use is below the melting temperature of the respective plastic, namely approximately 15 degrees below the Vicat softening temperature.

The double layer component is preferably formed as a bipolymer stripe which works like a bimetallic stripe.

Examples of materials from which the layers can be produced are for example polyethylene, especially HDPE. Polyethylen is one of the most widely produced plastics in the world and therefore the cost is low. A ton of HDPE costs approximately € 1,600.00. Therefore, the cost of producing a stripe are extremely low. A solar cell with the size of one square meter costs about € 200.00. Thereby the solar cell has an efficiency of more than 10 percent. Although, a suitable heat engine having the double-layer components has a lower efficiency than a solar cell, it is at a fraction of the cost. The costs are significantly lower than that of a solar cell. HDPE has a melting temperature of 130 degrees and a Vicat softening temperature of 105 degrees. One layer may be made of stretched and annealed HDPE and the other layer of oriented HDPE. The thermal conductivity of HDPE is 0.4 watts per kelvin times meter. For example, a bipolymer stripe having a thickness of 1 mm and a width of 1 cm, a length of 10 cm and thus an area of 10 cm², then the thermal conductivity is 0.4 Watt per Kelvin. Thus, assuming an operating temperature difference of approximately 20 Kelvin, there is a heat conduction per strip of 8 watts or 8 joules per second. The heat capacity of HDPE is 1.9 Joules per gram times Kelvin.

The polyethylene used has a high density of more than 0.955 g/cm³ and/or a low degree of branching of less than 1.3 branches per 1000 carbon atoms. This has the advantage that a particularly strong variation of the coefficient of thermal expansion can be achieved in the layers. The density of HDPE is more preferably 0.963 grams per cm³ or more. Preferably the polyethylene has 1 branch per 1000 carbon atoms. As HDPE for example, Rigidex HD5502S from Ineos can be preferably used. This HDPE has a density of 0.955 grams per cm³ with a degree of branching of 1.3 branches per 1000 carbon atom. Alternatively, Rigidex HD6007S can be used by Ineos, which has a density of 0.962 g/cm³ and a degree of branching of less than 0.5 branches per 1000 carbon atoms.

It is desirable that the double-layer parts have a high thermal conductivity so that the heat engine has a high number of revolutions, as the cooling and heating of the strips is directly related to the number of revolutions.

Before the heat engine is described in detail, the production of the bilayer components is first discussed in more detail.

In a preferred embodiment, the layers are produced with two strips of high-density polyethylene (HDPE) with very different coefficients of expansion. The two strips are then bonded together to form a corresponding double-layer component. The special properties of HDPE are particularly useful. HDPE can have both positive and negative coefficient of thermal expansion and is therefore particularly suitable. To get the desired properties the HDPE has to be stretched. For this purpose, an isotropic sample is first prepared. This can be done by extruding far above the melting temperature or by the melting of pellets in a mold. The melting point of HDPE is approximately 130 degrees.

For stretching, the polyethylene may be extruded or pressed in the form of shoulder bars, which are afterwards stretched. Stretching can be done with a stretch factor of eight. That means that the length of the shoulder rods or the extruded strand is eight times longer after stretching. While stretching it is important to watch out for inclusions and necks. The diameter decreases to about ⅓ during stretching. The density also decreases rapidly to values such as 0.8 grams per cm³ In order to increase the density, the samples can be treated for ten minutes at 5600 bars in a high-pressure autoclave. The linear expansion coefficient then achieved, however, is independent of the pressure treatment, the modulus of elasticity would, however, also increase. The modulus of elasticity increases both by stretching and by the pressure treatment. A higher modulus of elasticity is desirable for use as a bimetal substitute material because the mechanical stress can be relatively high, and a high modulus of elasticity compensates for this. The strips thus obtained should have a coefficient of linear expansion of about −24×10 per Kelvin, so a negative linear expansion coefficient and thus pull together when they are heated. This process is reversible in the temperature range of −20 degrees to +40 degrees. The linear expansion coefficient is negative for samples stretched and more negative with increasing temperature. In order to obtain a strip having a particularly high coefficient of linear expansion the strips must be annealed to just below the melting temperature. This can achieve a coefficient of linear expansion of +160×10 per Kelvin. When a stretched HDPE layer is annealed just below the melting temperature, this results in a maximum coefficient of thermal expansion. Thus polyethylene, depending on the processing can have different coefficients of thermal expansion, although it still is chemically the same substance.

Next, the two strips are combined together to form a bilayer component. For this, the two strips can be glued. The strips can be either fully glued over the contact surface or glued only at the ends of the contacts. The bonding can be done with molten plastic. Alternative connection methods of the strips are riveting, welding and rolling. Connecting the two HDPE strip is simplified because both parts consist of polyethylene.

Alternative plastic materials may be (ethylene/vinyl acetate copolymer) EVA that has a linear coefficient of linear expansion between 25×10⁻⁴ 1/K and 200×10⁻⁶ 1/K. Alternatively, linear polyurethane having a linear expansion coefficient of 210×10⁻⁶ 1 K may be used. It is also conceivable to use polyamide 6 having a coefficient of linear expansion of 95×10 1/K or high density polyethylene having a linear expansion coefficient of 260×10 1/K. Further, it is conceivable to use nylon or nylon having a linear expansion coefficient of 16×10⁻⁶ 1/K.

In one embodiment there is a layer of carbon fibers and the other layer is made from polyamide or nylon. This also makes it possible to generate the effect at reasonable cost and a strong bi-metal. Polyamide fibers and carbon fibers have a chemical similarity and can therefore be connected well with each other. The operating temperature can be much higher. For example, the working temperature may not exceed 200 degrees. The carbon fibers may be used for the preparation of the bilayer components in particular in the form of carbon fiber rovings. A preferred embodiment comprises a layer of polyamide 12. This layer is connected to a layer of unidirectional carbon fiber rovings.

In order to increase the thermal conductivity of the double layer component, preferably at least one part has graphene as an additive. By this the bilayer components change their shape faster when heat is applied and thus the power of the heat engine is increased. The proportion of the graphene can be, in particular between 0.1% by mass to 80% by mass, in particular 1 Mass.-% and 60 Mass.-% of the layer. With, in particular, a layer of polyamide, in particular polyamide 12, with an additional portion of graphene together with a layer of unidirectional carbon fiber rovings, a corresponding double-layer component can be made.

It is also conceivable to use two layers of polyamide with different thermal expansion coefficients.

In one embodiment, a layer of polybutylene terephthalate is used. Polybutylene terephthalate is even better than polyamide because it is more impact-resistant and more heat-resistant. The service life of the double layer parts is thereby increased. At higher temperatures and by the higher E-modulus, the power is higher with polybutylene terephthalate in the heat engine in addition to the increased efficiency due to the higher temperature difference that is possible. The other layer may be formed by unidirectional carbon fiber rovings. The layer may further comprise polybutylene terephthalate and to increase the thermal conductivity with a portion of graphene. The graphene portion lies between 0.1% by mass to 80% by mass, in particular 1 Mass.-% and 60 Mass.-%.

The heat engine includes a plurality of bilayer components. The heat engine includes a wheel, a hub and a plurality of spokes. The spokes, the wheel and the hub are connected together. The spokes are at least partially designed as double-layer components.

The spokes are joined to the hub and the wheel so that they can still move, to not hinder the bipolymer effect. The spokes are preferably spaced apart uniformly circumferentially.

The spokes or the double layer components do not need to be in a straight line or in radial direction but can be arranged bent in one direction of rotation. One side of the wheel is a cold zone and the other zone is a heating zone. This results in that the double layer components deform under the influence of heat and thus the hub is no longer concentric with the wheel.

The wheel is prestressed in particular with a spring in one direction and the hub with a further spring in the opposite direction. The balance of power is influenced by the bias of the springs. Further, the balance may be influenced by gravity when the wheel is placed upright. In the cold zone, the bilayer components expand and in the warm zone, the bilayer components contract together. Depending on the construction or arrangement of the layers of the double layer components, this can also be the other way around, whereby then the bilayer components contract in the cold zone and extend in the warm zone. The wheel is moved, and the center of force then is no longer concentric to the hub. To compensate for this, the wheel then turns so that the center is back in force equilibrium point between the springs. Thus, the heated double-layer components are moving into the colder zone and cooled there. The same applies to cold bilayer components that are moved to the warmer zone. Thereby, a cycle of heating and cooling and thus a rotational movement is initiated. This rotary motion can be used to drive a generator. In this way, electrical energy can be generated. The wheel is used for fixing and for force transmission between the bilayer components in the warmer zone and the bilayer components in the cold zone.

The heat engine drives in particular an asynchronous generator.

To produce a corresponding double-layer component at least one of the layers is manufactured by extrusion, wherein the layers are joined in a further step with one another. It is conceivable that both layers are produced by extrusion. - -

In one embodiment, a layer is formed by carbon fiber rovings. The other layer can be applied to this carbon fiber layer by an extruder. The applied layer of plastic and or the carbon fiber layer are then preferably heated, after which the plastic layer and the carbon fiber layer are compressed. The compression and the heating may take place by the two layers being pulled together through a taper in a heated block. It can be a heatable metal block, for example an aluminum block with a taper. The taper may be wedge-shaped.

The layers adhere to each other and are connected by the molten plastic.

Thereafter, the ends can be enclosed with plastic in a further processing step, so that the ends of the carbon fibers are also well-connected to the plastic layer.

There are a variety of ways to produce bilayer components and to design the process and the heat engine.

Referring here to the independent patent claims and subordinate claims.

Hereinafter, a preferred embodiment of the invention with reference to the drawings and the accompanying description is explained in detail respectively.

In the drawing:

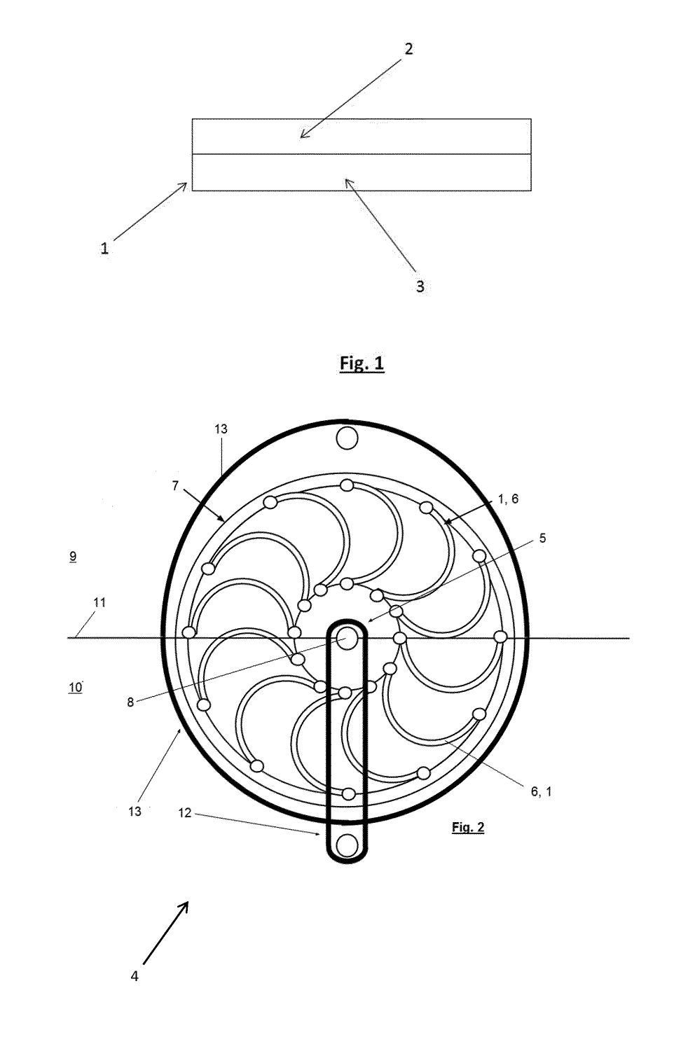

FIG. 1 is a schematic representation of a bilayer component.

,

FIG. 2 is a schematic, perspective view of a

Heat engine

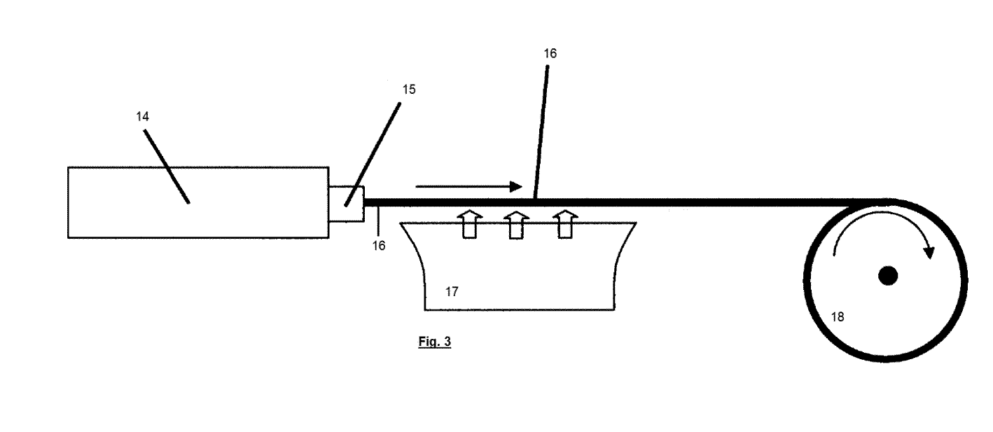

FIG. 3 is a schematic, perspective view of a

Extruder for producing a double-layer component according to FIG. 1, and. - -

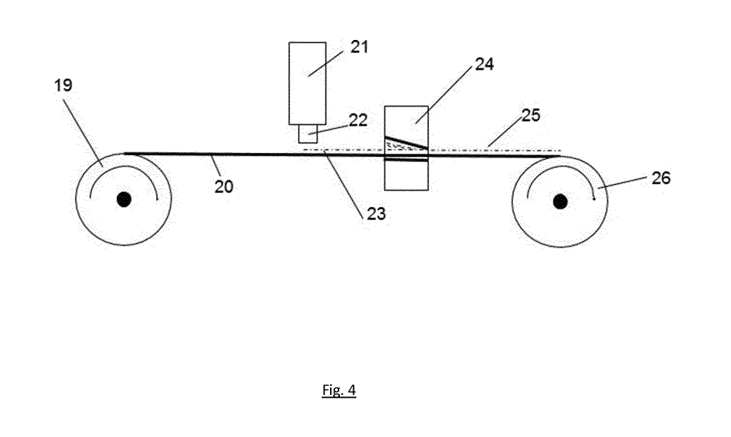

FIG. 4 is a schematic illustration of a further plant for

Preparation of bilayer components in FIG. 1.

In FIG. 1, a double-layer component 1 can be seen. The double layer component 1 comprises two layers 2; 3. The layers 2, 3 are connected full-surface to one another. In a preferred embodiment both layers 2, 3 consist of polyethylene. The one layer preferably has a positive coefficient of thermal expansion and in particular the other layer has a negative or lower thermal expansion coefficient than the other layer.

Both layers 2, 3 thus consist of a plastic. The double-layer component 1 may also be called bipolymer. The layer 2 can be produced from oriented polyethylene and the other layer 3 may be made of expanded polyethylene and tempered. As the polyethylene in particular, HDPE is used.

The total layer thickness of the double layer device 1, i.e. the sum of the thicknesses of the layers 2, 3 is preferably 0.1 mm or more than 0.1 mm, preferably 0.5 mm or more than 0.5 mm. In this way, sufficiently large forces can be generated in order to use the corresponding double-layer component 1 in a heat engine 4, which is shown in FIG. 2.

The thermal motor 4 has a hub 5, a plurality of spokes 6, and a wheel 7. The hub 5 is connected to a shaft 8, wherein a generator (not shown) via the shaft 8 is driven. The generator is used to generate electricity. The heat engine 4 is in a warm zone 9 and a cold zone 10. The transition region between the warm zone and the cold zone is represented by a schematic parting plane 11 here. The warm zone and the cold zone are preferably separated from each other by a heat-insulating wall in the plane of separation.

The spokes 6 are designed as double-layer components. 1 The bilayer components 1, i.e. the spokes 6 deform under heat. The bilayer components 1, i.e. the spokes bend 6 more strongly so that the radial distance between the hub 5 and the wheel 7 decreases under the effect of heat, in the hot zone. The hub 5 is defined by a first spring 12 and that wheel 7 is biased by a second spring 13 in the opposite direction. The spring 12 and 13 may be formed as elastic strips, in particular as rubber bands here. In an alternative embodiment, it is conceivable to use springs, for example helical springs, plate springs or the like to bias a corresponding position of the hub 5 and a position of the wheel 7 in the opposite direction. It is conceivable that only one spring 12 is provided, and the respective other part, i.e. either the wheel 7 and the hub is stationary 5 here. The spring 12 pulls the hub 5 in the colder zone 10 and the spring 13 moves the wheel 7 in the warmer zone 9. The deformation of the spokes 6 through heat now shifts the balance of forces, so that a compensating movement by the wheel 7 by rotation is performed, which is available by the shaft 8 in the form of electrical energy through the generator. This effect is indeed alone already observable by the wheel 7 being disposed upright in the gravitational field of the earth but here, it is additionally supported by the spring 12, 13. By the heat engine 4 waste heat from power plants or waste heat in the industry is very easy to convert. The heat engine 4 is characterized in that the spokes 6 are very cheap to manufacture and in addition, is working in a temperature range of −20 degrees Celsius to 40 degrees Celsius, wherein a heat difference between the hot zone and the cold zone of for example 20 degrees Celsius, is sufficient to drive the heat engine. The heat engine 4 drives in particular an asynchronous generator.

In FIG. 3, a preferred method for the preparation of the corresponding layers 2, 3 is shown. It shows a plastic extruder 14 which presses a molten resin through a nozzle 15. The nozzle 15 has a rectangular cut-out for the production of the respective stripes. The string 16 coming out of the nozzle 15 is now first passed to a fan 17 and finally wound up on a roll 18. The winding speed of the roller 18 is preferably higher than the feed rate of the string 16 through the nozzle 15 so that the strand 16 is stretched during winding. The strand 16 may be stretched 8 times.

The coiled material is now used to produce a corresponding bilayer 2, 3. Another likewise produced stripe is now additionally annealed to obtain a different coefficient of thermal expansion as the other layer. These two stripe materials are now cut accordingly to pieces of material in the strip length and on the full-surface bonded together. This can be done by bonding with molten polyethylene. In particular, molten polymer for joining the layers can be used.

A gentle bonding is needed, wherein the temperature of the layers is not increased so that the effect of the annealing is preserved. For example, a molten polyethylene wire can be used.

In this way particularly cost-effective bilayer components 1 can be produced.

It is conceivable to extrude a plastic material and stretch it during winding and thereby directly connect it with a layer of carbon fibers, which are supplied from another roller.

In FIG. 4, a further production method for the production of double layer parts 25 is shown. A carbon fiber layer 20 is first unwound from a roll 19 with carbon fiber rovings. By means of a plastic extruder 21, a plastic layer 23 is then applied through a die 22 to the carbon fiber layer 20. Thereafter, the two layers are pulled through a taper to heat and compress the two layers. The taper is preferably formed in a heatable metal block. For example, a heatable aluminum block can be used, with a taper 24. The plastic layer 23 and the carbon fiber layer 20 are heated while passing through the rejuvenation and are compressed by it. The plastic layer 23 is thus printed on the carbon fiber layer 20. The result is a strand 25 of a double-layer component. The strand 25 can be initially wound onto another roll 26. Thereafter, the string can be unwound again and the 25 individual double-layer components can be cut out of the strand (not shown). Thereafter, the ends can be enclosed with plastic in a further process step, so that the ends of the carbon fibers are well-connected to the plastic layer 23.

### LIST OF REFERENCE NUMBERS

1 double layer component
2 layer
3 layer
4 Heat Engine
5 hub
6 spoke
7 wheel
8 shaft
9 warm zone
10 cold zone
11 parting line
12 spring means
13 spring means
14 plastic extruder
15 nozzle
16 stranded
17 fan
18 role
19 roll with carbon fiber rovings
20 carbon fiber layer
21 plastic extruder
22 nozzle
23 Printed plastic layer
24 aluminum block with tapering to the heating and compression of the two layers
25 train for double-layer component
26 role for winding

1. Double layer component (1) with a first layer (2) and a second layer (3), said layers (2, 3) are connected to each other, wherein the two layers (2, 3) have different coefficients of thermal expansion, wherein the first layer (2) consists of a first polymer and the second layer (3) of a second polymer or carbon fibers, wherein the double layer component (1) is reversibly deformable under the influence of heat, characterized in that the double layer component (1) is insertable in a heat engine (4) wherein the thickness of the double layer component (1) is at least 0.1 mm, wherein the thickness of the double layer component (1) is 5 cm or less than 5 cm.

2. Double layer component according to claim 1, characterized in that the thickness of the double layer component (1) is at least 0.5 mm.

3. Double layer component according to one of the preceding claims, characterized in that the width of the double layer component (1) is in the range between 1 cm and 50 cm.

4. Double layer component according to one of the preceding claims, characterized in that the length of the double layer component (1) is between 5 cm and 100 cm.

5. Double layer component according to the preceding claim, characterized in that the length is between 10 cm and 20 cm.

6. Double layer component according to one of the preceding claims, characterized in that the double layer component (1) has the shape of a stripe, wherein the length of the stripe is greater than the width and the thickness.

7. Double layer component according to one of the preceding claims, characterized in that at least one of the layers (2, 3) consists of polyethylene wherein the polyethylene has a density of more than 0.955 g/cm³ and or a degree of branching of less than 1.3 branches per 1,000 C atoms.

8. Double layer component according to one of the preceding claims, characterized in that a layer (2) is made of stretched and annealed HDPE (High Density Polyethylene) and the other layer (3) is made of stretched and unannealed HDPE.

9. Double layer component according to one of the preceding claims 1 to 7, characterized in that one layer comprises carbon fibers.

10. Double layer component according to one of the preceding claim 1 to 7 or 9, characterized in that at least one of the layers comprises polyamide.

11. Double layer component according to one of the preceding claims 1 to 10, characterized in that at least one of the layers has graphene as an additive.

12. The heat engine (4) having a plurality of double layer components (1) according to one of the preceding claims, characterized in that the thermal motor (4) comprises a hub (5), a plurality of spokes (6) and a wheel (7), said spokes (6) are connected with the wheel (7) on the one hand and to the hub (5) on the other hand, wherein the spokes (6) are formed by double layer components (1).

13. Heat engine (4) according to the preceding claim, characterized in that the hub (5) and or the wheel (7) are functionally effectively connected by springs (12, 13) radially to the rotational direction.

14. A method for producing a double layer component according to one of the preceding claims, characterized in that at least one of the layers (2, 3) is produced by extrusion, wherein the layers are joined in a further step with each other.

15. Method according to the preceding claim, characterized in that the layers (2, 3) are bonded together.

16. Method according to the preceding claim, characterized in that the layers (2, 3) are connected by molten plastic.

17. Method according to one of the preceding claims, characterized in that a plastic layer (23) by means of an extruder (21) is applied to a carbon fiber layer (20), wherein the applied plastic layer (23) and/or the carbon fiber layer (20) is heated, whereby the plastic layer (23) and the carbon fiber layer (20) are compressed.
